(19) United States
(12) Patent Application Publication
(10) Pub. No.: US 2012/0199571 A1
(43) Pub. Date: Aug. 9, 2012

(54) Pressurized Cooking Oven

(76) Inventor: Christopher Brown, Kamloops (CA)

(21) Appl. No.: 13/343,961

(22) Filed: Jan. 5, 2012

Related U.S. Application Data
(60) Provisional application No. 61/441,114, filed on Feb. 9, 2011.

(51) Int. Cl. F24C 1/14; A47J 27/04; F24C 15/02; A47J 27/09

(52) U.S. Cl. 219/401; 126/369; 126/389.1; 126/197; 99/467

(57) ABSTRACT

Disclosed is a pressurized oven apparatus having a compressor and a pressurized chamber for rapidly preparing food products and retaining internal moisture therein. The apparatus comprises an oven with a pin-locking door and sealing means, an internal chamber having heating elements and a structure designed to withstand elevated internal pressures. Ambient air is drawn into the device through an air filter by an air compressor means. The compressor elevates the air pressure as it enters, whereby it flows to a preheating chamber, raising its temperature prior to being forced into the oven internal chamber. An automated relief valve system allows a consistent pressure to be maintained within the chamber, allowing the pressurized air to be evacuated therefrom through an insulated and muffled outlet. The air outlet of the device is preferably connected to an insulated air line to vent air to the exterior of a building or residence.

### CROSS REFERENCE TO RELATED APPLICATION

This application claims the benefit of U.S. Provisional Application No. 61/441,114 filed on Feb. 9^{th}, 2011, entitled “Pressure Oven.”

### BACKGROUND OF THE INVENTION

1. Field of the Invention

The present invention relates to commercial and residential food ovens. More specifically, the present invention relates to a pressurized oven device having an internal pressurization for decreasing cook time, temperature penetration into a food product and moisture retention. Ambient air is drawn through an air filtration means and into an air compressor to pressurize a sealed cooking chamber, whereby the pressurized air is heated using a preheating chamber and oven chamber heating elements to provide a high temperature and high pressure cooking environment that improves preparation of food products over conventional oven devices.

Traditional oven cookers utilize an internal heating element to raise the temperature of an oven chamber in a process that cooks a food product over a specified period. These devices provide a common means to slow cook food, whereby the internal temperature of the device is gradually raised to an appropriate level prior to food being placed therein. The duration of cook time for products in these devices can be considerable, due to the need to preheat the oven and then allow heat to penetrate the food product and raise its internal temperature to an acceptable level prior to consumption. The duration of cooking, and the inevitable loss of moisture within the food product, remains a common drawback to this conventional cooking means. The long cooking duration and ambient pressure allows moisture to escape the food product, resulting in a drying process that reduces food flavor.

More rapid means of cooking food products includes a microwave oven device, which utilizes a dielectric heating process to raise the temperature of the water, fat and other elements in the food to cook the product. Microwave radiation is used to heat polarized molecules within the food product, heating the food and cooking it in a rapid and convenient process. While reducing cooking time, microwave ovens are known to significantly reduce the moisture content and subsequent taste of a food product after cooking, which is a similar drawback to conventional oven devices.

Still further available are pressure cooker devices, which utilize high temperature steam to cook food in a high pressure environment. These devices are typically stove-top heated chambers that allow steam and water to elevate in temperature above local atmospheric boiling temperatures. This elevates the temperature of the food product above what is normally possible without pressurization and increases cooking time. While useful for their given task, these devices utilize the vapor pressure of water to boil or steam-cook a food product, limiting the type of food product that can be prepared therewith.

It is therefore evident that a need in the art exists for a device that accelerates the cooking process of a food product to an appropriate level, while maintaining its internal moisture, freshness and flavor content. A device is required that rapidly cooks a food while not limiting the particular food type to a boiling process, and one that does not detract from the quality of the product as the food is cooked. The present invention provides a pressure cooking oven device that utilizes a high pressure and high temperature environment to rapidly penetrate food products using compressed air that is filtrated and alternatively humidified to maintain a cooking environment that rapidly increases the temperature of food and prevents moisture loss. The penetrating nature of the pressure resists moisture dissipation from the food, while the filtration reduces any airborne content that may contaminate the food product during pressurization. A preheating chamber is used to rapidly raise the air temperature prior to introduction into the cooking chamber, furthering the ability of the oven to maintain an elevated temperature and raise the internal temperature from ambient. A relief valve and muffler exhaust allow heated, pressurized air to be evacuated therefrom when cooking is completed or when access to the oven chamber is required.

2. Description of the Prior Art

Devices have been disclosed in the prior art for pressure ovens, cooking devices and means of construction. These devices have familiar design features for providing high pressure chambers, including means for closure and isolation of the internal pressure chamber and pressure relief systems. These devices, however, fail to disclose the filtration, preheating means and exhaust elements of the present invention, and further fail to disclose the features of the present invention oven door locking and sealing mechanism. The devices in the prior art are well adapted for their particular requirements, but fall short of disclosing a novel residential or commercial cooking device that utilizes high pressure and the elements of the instant invention.

Specifically, U.S. Pat. No. 1,802,328 to Belser discloses an improvement to pressure ovens, wherein a pressure regulating system is described for use controlling the cooking oven internal pressure. To prevent overly high pressures that would otherwise destroy a food product or the oven apparatus itself, a suitable safety-valve is provided to relieve excess pressure within the oven when a desired pressure has been exceeded. A super-heater provides a heating means to raise the pressurized air temperature within the oven. The Belser device describes a practical safety mechanism for controlling and preventing over-pressurization of a pressure cooking oven. The safety-valve relieves pressure to regulate the internal environment within the oven while cooking. The elements of the oven are not disclosed to permit one to build a suitable pressure cooking device, but rather a safety mechanism therefor is described.

U.S. Pat. No. 5,505,975 to Taylor further describes a method for high temperature, high pressure cooking of poultry and similar food products using superheated steam and super-atmospheric compressed air at an elevated temperature. The method is practical for commercial kitchens and fast food restaurants serving otherwise slow-cooked food, such as roasted poultry, and allowing the cooking time to be accelerated for increased production or decreased time required to prepare the food product. Steam is generated from a water source which improves yield and increases cooking by condensing on the relatively cold meat product. The Taylor method is particularly suited in a commercial environment, wherein high volume is necessary and minimal cooking time is required to meet demand. Further, the structure required to fulfill the method differs from the present invention.

U.S. Published Patent Application Publication No. 2010/0310733 to Hoffman describes a pressurized oven enclosure that utilizes an internal pressure above atmospheric during at least a portion of the cooking process, and a means for controlling the heating and pressure. A venting system connected to the enclosure vents air from within the enclosure, while a control system regulates the internal pressure and temperature utilizing at least one pressure and temperature sensor. A locking mechanism is also disclosed for preventing the door from rotating about its hinge during pressurization. While the Hoffman device discloses an apparatus for creating a high temperature and high pressure cooking environment, the device fails to incorporate all elements of the present invention. In particular, an air filtration means, preheating chamber and muffling exhaust element is not disclosed.

U.S. Pat. No. 5,297,473 to Thelen discloses a pressure cooker with a pressure tight cover and a locking mechanism around the rim of the cover. Members within the cover are movable radially inward and outward to engage a container rim and prevent opening of the cover due to the internal pressurization. A locking shoulder within the wall of the container and a sealing shoulder are further provided. In the radially outward locking position, the closing members brace against the locking shoulder and the sealing shoulder having a sealing ring. The Thelen device discloses a locking means for a pressure cooking pot, which is utilized on a stove top for sealing a chamber of liquid to create a high pressure steam environment that is above ambient pressure conditions. The elements of the locking means differs in design elements from that of the present invention, wherein a hinged door having a plurality of locking pins and stepped sealing shoulder is disclosed.

The present invention provides a novel apparatus that comprises a high pressure and high temperature chamber having a securely locked, hinging door. Ambient air is drawn through an air filtration means and into a compressor, which raises the pressure of the air before sending it through a preheating chamber. The preheating chamber is an electrically heated or gas heated device that rapidly heats the air flowing therethrough prior to its entrance into the oven heating chamber. The preheated air accelerates the oven's ability to reach a desired cooking environment, and allows improved regulation and control of the temperature and pressure in the chamber. A relief valve system works in conjunction with the incoming air to regulate the internal pressure. A control system automatically maintains a preset pressure/temperature by releasing internally pressurized air through an insulated air hose and introducing heated air into the chamber. Air is released through a sound muffling means into an external environment. This provides a means to regulate the pressure without introducing considerable heat or noise into the immediate vicinity of the oven. The construction of the oven is designed to withstand the high pressure environment, and may resemble a standard kitchen oven appliance from the exterior.

In light of the disclosed prior art and the disclosed elements of the present invention, it is submitted that there exists a clear need for a device that provides a pressurized cooking environment for rapidly preparing food products without reducing flavor or freshness. An optional humidifier releases humidified air or water vapor into the chamber for preventing over-drying, while the pressure penetrates the food product and prevents moisture loss. The present invention is substantially divergent in design elements from the prior art, and consequently it is clear that there is a need in the art for an improvement to existing pressure oven devices. In this regard the instant invention substantially fulfills these needs.

### SUMMARY OF THE INVENTION

In view of the foregoing disadvantages inherent in the known types of pressure oven devices now present in the prior art, the present invention provides a new pressure oven device wherein the same can be utilized for providing convenience for the user when rapidly preparing food products in a manner that retains flavor, moisture and freshness content.

It is therefore an object of the present invention to provide a new and improved pressure oven device that has all of the advantages of the prior art and none of the disadvantages.

Another object of the present invention to provide a pressure cooking oven having an internal oven chamber that provides a high pressure and high temperature environment to facilitate heat penetration into a food product.

Another object of the present invention is to provide a pressure oven apparatus having an air filtration means to filter incoming air, preventing airborne particles and contaminates from entering the oven chamber and penetrating the food product.

A further object of the present invention is to provide a pressure oven apparatus comprising a preheating chamber to allow the oven chamber to be filled with heated air, reducing the time required to elevate the oven internal temperature and allowing improved control over the oven environment using ambient or heated air in conjunction with a relief valve system.

Yet another object of the present invention is to provide a pressure oven apparatus with a hinged and pin-locking door that contains the heated and pressurized air within the oven chamber, while providing visualization of the oven internal contents during use.

Another object of the present invention is to provide a pressure oven apparatus having an insulated exhaust system using a relief valve system, insulated air lines and a noise muffling means to evacuate pressurized air from within the oven chamber in a safe and quiet manner.

A still further object of the present invention is to provide a pressure oven apparatus that reduces cooking time of products when compared to non-pressurized ovens, while providing a means to rapidly cook the product and retain its freshness and internal moisture content prior to consumption.

A final object the present invention is to disclose a novel structure designed to withstand the high pressure and high temperature environment of the disclosed invention, while providing a means for inspection of the food product when desired and a means to evacuate the internal pressure and heat to the external environment.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 there is shown a schematic diagram of the pressure oven of the present invention.

FIG. 2 there is shown a front perspective view of an embodiment of the present invention with its door removed for visualization purposes.

FIG. 3 there is shown a cross-section view of the present invention door locking shoulder.

FIG. 4 there is shown a perspective view of the present invention door and its pin-locking means.

### DETAILED DESCRIPTION OF THE INVENTION

Reference is made herein to the attached drawings. Like reference numerals are used throughout the drawings to depict like or similar elements of the pressure oven apparatus. For the purposes of presenting a brief and clear description of the present invention, the preferred embodiment will be discussed as used for rapidly preparing food products in a high temperature and high pressure environment. The figures are intended for representative purposes only and should not be considered to be limiting in any respect.

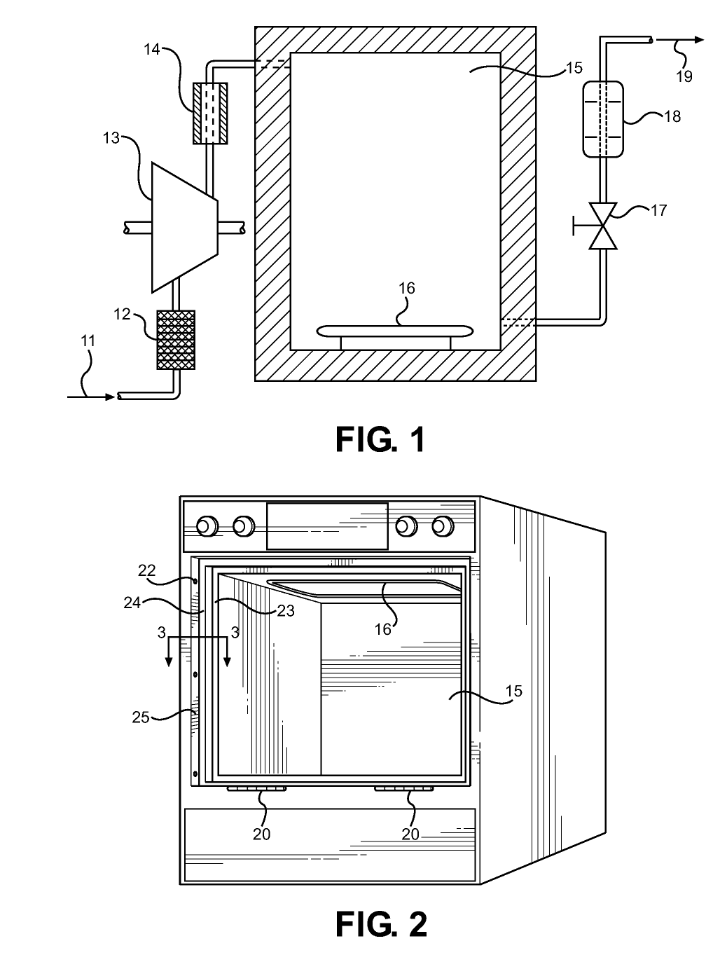

Referring now to FIG. 1, there is shown a schematic view of the pressure oven device of the present invention. The elements of the device are represented in a system diagram to illustrate the flow of ambient air into the device, the elements that provide for pressurization, heat and finally exhaust of the air into the external environment. As shown, air enters 11 the device and is drawn through an air filtration means 12 by a vacuum created by an air compressor 13. As air passes through the filter, dust and airborne contaminants are removed therefrom prior to being compressed and ultimately communicated into the cooking chamber 15. The air filtration means 12 may comprise a high flow, high efficiency air filter or plurality of filters that remove particulates such as dust, pollen, mold and bacteria that could otherwise contaminate the food product. The air compressor 13 is an electrically-driven device that compresses the air to a pressure above ambient. The compressor may be provided as a piston-driven, rotary or any commonly used compressor means that effectuates a high pressure output. The high pressure air then exits the compressor and flows to a preheating chamber 14. Alternatively, the air filtration means 12 may be provided on the output side of the air compressor 13 to prevent stifling or stagnation of the compressor inlet.

The preheating chamber 14 is a device that rapidly heats the air passing therethrough. This device may be provided as a gas-powered or electrically-powered heating device, similar to a gas or electric heat gun, wherein the compressed air is rapidly heated prior to being forced into the oven internal chamber 15. The preheating chamber allows the oven to rapidly elevate temperature from ambient when preheating the oven, and provides further control and regulation of air temperature within the chamber 15. The preheating chamber may be regulated as needed to different temperature settings, and even turned off if ambient temperature air is requested within the heating chamber to maintain a desired level therein.

After passing through the preheating chamber, the high temperature and high pressure air is released into the oven chamber 15, which is a large internal volume wherein food products are placed and cooking occurs. Similar to a conventional oven, internal heating elements 16 provide a means to control the air temperature therein by heating the air and switching on or off when required. The walls of the device are designed for thermal insulation and pressure containment. The construction of the device must be such that the high temperature and high pressure air within the chamber is contained and regulated, preventing the possibility of rupture. The high temperature and high pressure within the chamber 15 allows heat to rapidly penetrate a food product and prevent moisture from leaving the product as easily as a conventional oven. Cooking time is lowered and the flavor content is preserved. An alternate embodiment of the pressure oven contemplates a humidifier in series with the incoming air to increase the moisture content and further prevent moisture loss of the food product while being cooked. The humidifier adds water vapor to the air flowing in, preferably after compression and preheating, to add vapor to the oven chamber 15 and prevent drying of the food.

Regulating the internal environment of the oven chamber 15 is crucial for cooking food at an appropriate level and preventing an environment that can lead to failure of the oven elements and structure. Air pressure and temperature are monitored inside the oven chamber 15 by pressure and thermal sensors, and an electronic control system controls the volume, pressure and temperature of incoming air via the preheating chamber 14 and compressor 13, and further controls the release of air from the oven chamber 15 via a relief valve system 17. The relief valve 17 opens and closes when directed by the control system, and releases the high temperature and high pressure air within the oven chamber 15 into an insulated air line. The same type of insulated air lines are used on the inlet side, connecting the compressor 13, preheating chamber 14 and oven chamber 15. Air rapidly vents through the relief valve 17, whereby it passes through a sound muffling means 18. The muffler 18 is placed near the outlet 19 of the air line, in proximity to where the air is released into the external environment. The muffler 18 reduces the noise associated with the rapid flow of gas, its expansion and release from the oven to the ambient environment, wherein the air is much lower in pressure and temperature. Muffling the sound prevents noise from the oven while the control system continually regulates the internal environment, and further when access to the oven chamber is requested by the user and the chamber must be vented of any high pressure air.

Referring now to FIG. 2, there is shown a front perspective view of a pressure oven structure as provided by the present invention, wherein the hinged 20 oven door is removed for visualization purposes. As shown, the oven device may take the form of a conventional, residential oven appliance, wherein the filtration, compressor, preheating and relief valve elements are stored below and behind the oven chamber 15. The internal heating elements 16 are provided within the chamber 15 along the ceiling and/or along the base of the chamber 15 to allow broiling and traditional baking.

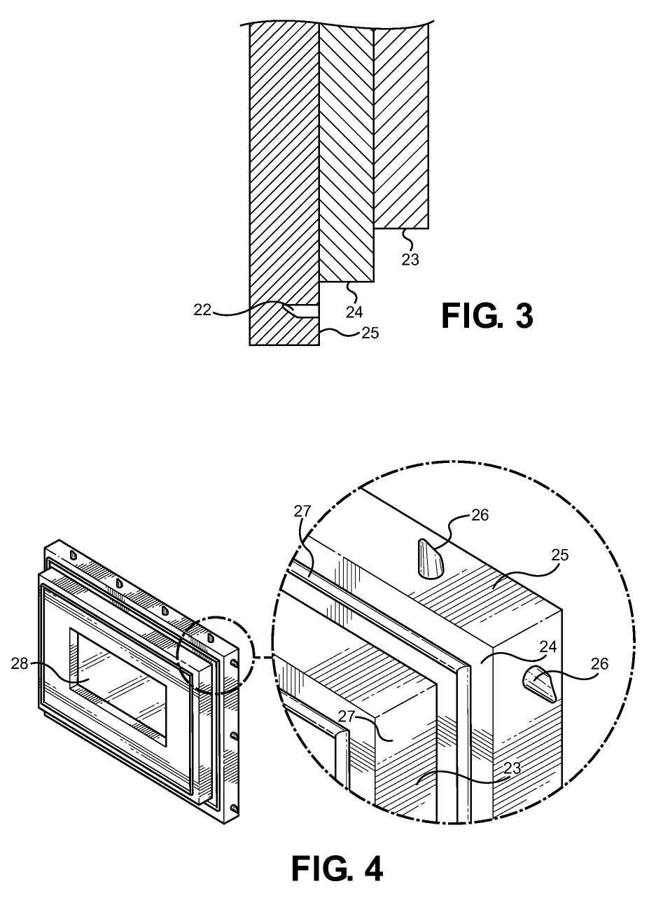

The structure of the oven is of particular interest, as the environment within the oven is of high pressure and high temperature. The structure must provide a sufficient pressure vessel and thermal barrier, while still allowing access to the internal contents and visualization of the food while cooking. The oven door is a hinged 20 structure that mates against the oven in a secure fashion, wherein a sealed and locking shoulder region is provided to maintain the door in a locked position while the oven is in use. The shoulder region comprises an internal 23 and intermediate 24 shoulder, each having a sealing means, and an outer shoulder 25 having a plurality of pin-locking apertures 22. As shown in FIG. 2, there is a cross section cutline that is visualized in FIG. 3.

Referring now to FIG. 3, there is shown an overheard cross-section view of an embodiment of the oven door locking shoulder. As shown, the oven shoulder comprises an inner 23, intermediate 24 and outer 25 shoulder surface. The inner 23 and intermediate 24 surfaces employ a sealing means, such as a gasket, while the outer shoulder surface 25 employs a plurality of pin-locking apertures 22 for securing the door in a sealed and closed position. The angle of the pin-locks and apertures is adapted to force the door inward towards the oven cavity, wherein a gasket lining the shoulder is compressed and an air tight seal is created. The pins are mechanically engaged members that are adapted to extend from the periphery of the oven door and retract back into the oven door via a mechanical control, such as an internal drive screw or gearing mechanism that allows travel of each pin outward from the door to engage the apertures 22 positioned in the shoulder of the oven for creating an air tight, secured closure of the door to counteract internal pressurization.

Referring now to FIG. 4, there is a view of an embodiment of the oven door of the present invention, wherein the features of the pin-locking means and oven shoulder engaging region of the door is magnified. In this view, the shape of the pins 26 is better visualized, along with their outward chamfer direction. The pins are mechanically controlled and driven from the interior of the door when the oven is operating and pressurized. The pins comprise a chamfered distal end, wherein secure closure of the oven door is facilitated as the chamfer contacts the oven associated apertures 22 within the outer shoulder surface 25 and presses the oven door inward towards the cavity as the pin completely engages the aperture. Once the pins 26 are aligned with the apertures 22 along the oven outer shoulder surface 25, they are mechanically driven into place to secure the door closed. The pins may be retracted upon request of the user, wherein the oven control system turns off the compressor and vents the internal pressure within the oven through the relief valve system. The pins 26 are then retracted and the door is free after the pressure has returned to ambient, allowing the door to be opened about its hinge. Sealing gaskets 27 along the inner 23 and intermediate 24 shoulder surfaces are compressed between the door and the oven, and ensure an air tight seal that is adapted to contain the high pressure within the oven chamber during use. Visualization of the food contents within the oven during operation is achieved through a tempered glass window 28 on the door. The window 28 is adapted to withstand the operating temperatures and pressures within the oven, and allow a user to monitor the food as it cooks.

The oven is adapted to work with either gas power or pure electric. The oven heating elements and preheating chamber may be provided using a gas-powered heat source, or alternatively an electric heating coil and preheating chamber electric heating device similar to a heat gun. The electric heating device utilizes electric power to effectuate an intense heat exchange with the air passing through the preheating chamber, rapidly increasing its temperature prior to being forced into the oven. Once inside the oven, the filtered and alternatively humidified air penetrates food products and accelerates the cooking process without sacrificing food quality and taste. Internal circuit logic and associated electronics control the operation and safety systems of the oven, including regulating the incoming air conditions, internal oven conditions and controlling the relief valve system. This allows independent control of the oven, wherein the user can set the temperature and a pressure setting, and the oven automatically operates at the desired levels for a given period of time. Air is compressed, heated and contained within the oven, vented when necessary and regulated during the entire process. The oven door is locked and secured in place until access to the internal oven chamber is required, wherein the high pressure gas is vented through the relief valve system.

Overall, the high pressure and high temperature environment, and the ability to be provided to the user in a residential or commercial kitchen environment, provides a means to rapidly cook a food product, retaining its internal moisture, flavor and quality. The high temperature air penetrates the food more rapidly, raising its internal temperature faster than a conventional oven, and in a manner more adapted to preserve the quality of the food than microwave ovens. It is submitted that the disclosed invention provides a novel oven cooking means that incorporates elements that are not found in conventional, pressure or microwave oven devices.

It is further submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pressure oven cooking device, comprising:
an oven chamber adapted to contain an internal volume of elevated pressure and temperature air for cooking a food product, said chamber having internal heating means;
an air filtration means for filtering said air;
an air compressor for raising said air pressure above ambient pressure;
a pressure relief valve system for venting said pressurized air from said oven chamber;
said oven chamber further comprising a door access with locking means for containing said pressurized air.

2) The device of claim 1, further comprising a preheating chamber to elevate said air temperature prior to its entry into said oven chamber.

3) The device of claim 1, further comprising a sound muffling means in series with said relief valve system for reducing exhausted air noise.

4) The device of claim 1, further comprising an insulated air conduit between said preheating chamber and said oven chamber, and between said oven chamber and said relief valve system.

5) The device of claim 1, wherein said heating means comprises electric heating coils.

6) The device of claim 1, wherein said heating means comprises gas heating means.

7) The device of claim 1, wherein said door access locking means further comprises a shoulder region, a sealing gasket and a plurality of pin-locking mechanisms for securing said door.

8) The device of claim 7, wherein:
said shoulder region further comprises an internal shoulder surface, an intermediate shoulder surface and an outer shoulder surface;
said inner and intermediate shoulder surfaces having a sealing gasket;
said outer surface having a plurality of pin-lock apertures to accept mechanically deployable pins within said oven door for securing said door to said shoulder region during oven operation.
